(19) United States
(12) Patent Application Publication
(10) Pub. No.: US 2026/0119076 A1
(43) Pub. Date: Apr. 30, 2026

(54) MEMORY DEVICES AND METHODS FOR MEMORY DEVICES

(71) Applicant: Intel Corporation, Santa Clara, CA (US)

(72) Inventors: Tina C. TOUPAL, Portland, OR (US); Stephen MOREIN, San Jose, CA (US); Wei WU, Portland, OR (US); Scott CLINE, Portland, OR (US)

(21) Appl. No.: 19/432,159

(22) Filed: Dec. 24, 2025

Related U.S. Application Data
(60) Provisional application No. 63/827,038, filed on Jun. 20, 2025.

(51) Int. Cl. G06F 3/06

(52) U.S. Cl. CPC G06F 3/0655; G06F 3/0604; G06F 3/0673

(57) ABSTRACT

In embodiments, a memory device includes a memory including at least one memory die layer and a memory controller operatively coupled to the memory. The memory controller is configured to: obtain read/write request for a targeted portion of the memory; obtain data from the targeted portion of the memory in response to the read/write request; and perform a hybrid data correction on the portion of the targeted memory. Performing the hybrid data correction includes performing a Reed Solomon error correction on the data from targeted memory portion; performing Erasure error correction on the data from the targeted memory portion; and correct the targeted memory portion based on outputs of the performed Reed Solomon error correction and the performed Erasure error correction.

### CROSS-REFERENCE TO RELATED APPLICATION

This non-provisional application claims priority U.S. provisional application 63/827,038, the entire contents of which are incorporated herein by reference filed on Jun. 20, 2025.

### BACKGROUND

To increase memory density for computing, 3D stacked memory devices—comprising multiple closely coupled DRAM layers—have been developed. These memory stacks can integrate components like memory controllers and CPUs to deliver substantial memory capacity within a single package.

Some memory data error detection approaches, for 2D and 3D memory devices, focus on “bounded faults”, a predefined boundary. Such approaches limit the shape of the error pattern. Some correction methods require more error correction code (ECC) symbols and complex correction algorithms to handle faults that are out of bound.

In addition, stacked memories or 3D memories have new or different error types due to sharing of the data lines across all bursts. Certain types of such errors may be difficult to detect or repair and may produce inaccurate data.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 shows a diagram illustrating an example of a memory device including a memory controller and a memory comprising one or more memory die layers according to one or more aspects;

FIGS. 2-3 each includes a representation of memory sections according to one or more aspects;

FIGS. 4-5 each show a flow chart of a method according to one or more aspects of the present disclosure;

FIG. 6 shows a diagram illustrating an example of a memory arrangement including a memory device and a host controller according to one or more aspects;

FIGS. 7A, 7B, 8 each show a flow chart of a method according to one or more aspects; and

FIG. 9 shows a diagram illustrating an example of a memory device including a memory controller and a memory comprising one or more memory die layers and a method of using it according to one or more aspects.

### DESCRIPTION

The following detailed description refers to the accompanying drawings that show, by way of illustration, specific details and aspects in which the disclosure may be practiced. One or more aspects are described in sufficient detail to enable those skilled in the art to practice the disclosure. Other aspects may be utilized and structural, logical, and electrical changes may be made without departing from the scope of the disclosure. The various aspects described herein are not necessarily mutually exclusive, as some aspects can be combined with one or more other aspects to form new aspects. Various aspects are described in connection with methods and various aspects are described in connection with devices. However, it may be understood that aspects described in connection with methods may similarly apply to the devices, and vice versa. Throughout the drawings, it should be noted that like reference numbers are used to depict the same or similar elements, features, and structures. That is, it should be understood that, for clarity and consistency, the same or similar reference numerals are used throughout the figures to denote the same or similar elements, components, or features. Variations of the embodiments may include different combinations of these elements, but the reference numerals will maintain their correspondence to the particular elements where applicable. Throughout the drawings, it should be noted that proportions are not necessary to scale and that the size of features may be emphasized for ease of illustration.

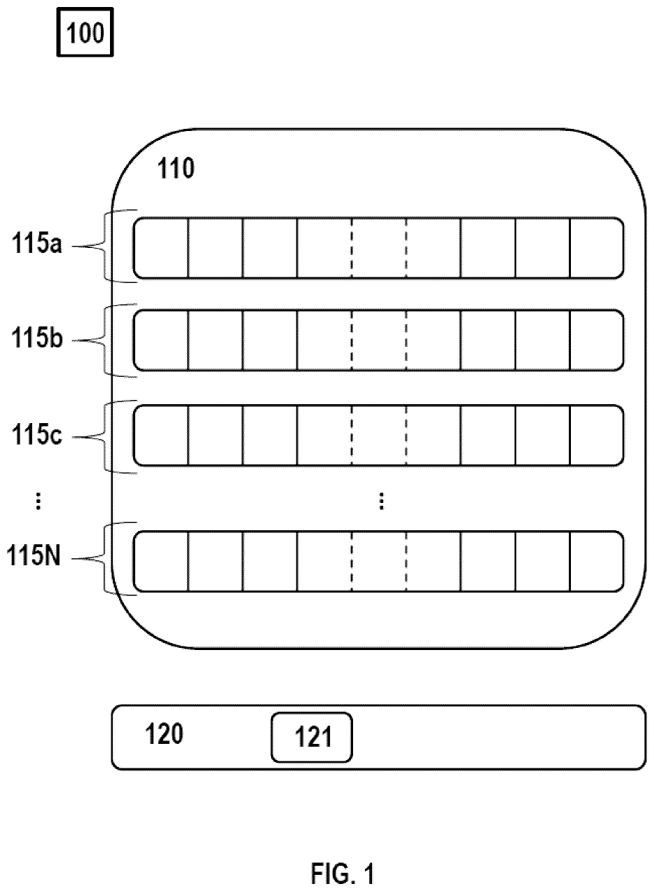

FIG. 1 an example of a memory device 100. The memory device 100 in this example can include a “3D stacked memory” 110. For example, 3D indicates three-dimensional or a “stacked memory” denoting a computer memory including multiple coupled memory layers, memory packages, or other memory elements. In the example of FIG. 1, the memory 100 includes the layers 115a-115N (or just 115) which are vertically stacked on each other.

As shown in FIG. 1, the memory device 100 includes multiple memory layers, labeled 115a through 115N (collectively referred to as 115), that are vertically stacked on top of one another. While vertical stacking is depicted here, memory elements may also be arranged in other configurations—such as horizontal (side-by-side) stacking—or in any layout where memory components are interconnected.

In at least one implementation, the stacked memory 110 may be a DRAM-based device in which each of the layers 115a-115N corresponds to a DRAM layer. Embodiments are not limited to any particular number of memory layers or memory die layers in the memory stack 110.

Additionally, the stacked memory device 100 may incorporate other system components, such as a central processing unit (CPU), a memory controller, or other related functional elements. These system-level components are collectively or individually represented by reference character 120 and may be integrated into a designated system layer within the device.

The system layer 120 can include a logic chip or a system-on-chip (SoC), depending on the implementation. To facilitate communication between the memory layers 115 and the system layer 120, the stacked memory device 110 may include through-silicon vias (TSVs), which provide vertical electrical interconnections across the die or memory layers. In certain embodiments, the logic chip may include specialized processors, such as an application processor or a graphics processing unit (GPU).

In at least one embodiment, the stacked memory device 100 includes a system element, e.g., in system layer 120 that is coupled to the memory stack 110. The memory stack 110 can includes one or more memory dies, where such memory dies may be manufactured by various different manufactures.

In at least one embodiment, the system layer 120 includes a memory controller 121 which is configured to control, e.g., at least some aspects of, the memory stack 110.

In any memory element that contains remap or repair tables, errors can arise in the storage element that implements the repair table. Some approaches typically discover an error when a data request comes through and requires an update to the table. This action adds latency.

Further, memory vendors typically provide extra memory space to accommodate repair usage. In a stacked memory device (e.g., memory device 100), this approach adds extra memory slices in a cube to improve the overall cube resilience.

As previously mentioned, some memory data error detection approaches focus on “bounded faults”, a predefined boundary, and some require more ECC symbols and complex correction algorithms to handle out-of-bound faults. However, in cases where there's insufficient ECC capacity, such as due to a lack of dedicated ECC devices, or due to the use of stacked DRAM like High Bandwidth Memory (HBM), then error correction for the DRAM system can only cover failures within the bank, such as sub-wordline failure, column-select-line failure, and random bit failures.

For instance, faulty bits can be in transit on the Double Data Rate (DDR) link, and different vendors have different bit placement approaches. In at least one case, the bit placement may be distributed across multiple DQ pins with one or few bursts, or it can be distributed to a few DQ pins across multiple or even all bursts. Such randomness makes the ECC algorithm hard to design.

DRAM ECC algorithms usually adopt or implement symbol-based code (such as Reed-Solomon RS code). For instance, each symbol covers a pre-defined cluster of bits. If a symbol is defined burst-wise, then the correction algorithm is inefficient for DQ-wise errors, and vice-versa. Since DDR5, DRAM vendors have begun defining a “Bounded Fault” approach to limit the shapes of the errors and therefore improve the efficiency of ECC codes.

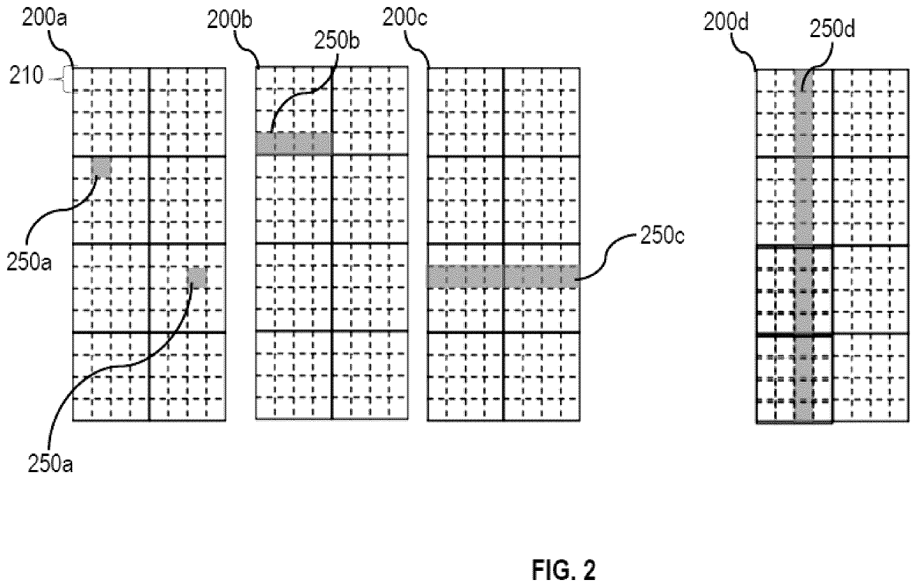

FIG. 2 shows stacked memories (200a-200d) illustrating some examples of memory faults within the memory sections 200a-200d. The memory sections 200a-200d can be planar or a stacked memory, with a data queue (DQ) denoted 210.

Zero allocation memory (ZAM), when implemented, faces the challenge that not all faults can be aligned to one single direction. Further, most DRAM faults (e.g., sub-wordline or column select faults) are mapped to one burst.

Memories 200b and 200d show mapped errors 250b and 250 as examples of burst errors. In the example of memory 200b, the error 250b is mapped to a portion of a memory layer or memory die, while in the case of memory 200c, the error 250c is mapped across the entire memory die/layer. By contrast, memory 200 shows the mapping of random bit errors, denoted as 250a.

In addition, since DRAM dies can be stacked in 3D memory, any via fault or link/connection fault may impact all bits from a series of data queues (DQs). This kind of error is a vertical error or fault (e.g., through multiple vertically stacked and aligned dies). An example of such an error is denoted as 250d in the depicted memory 200d.

The failures of memories 200a-200c can be considered a first type or kind of failure, namely internal failures. The failures of memory 200d can be considered as via or connector type failures.

Error correcting codes, such as Reed-Solomon (RS), can be used to correct DRAM failures or faults, such as, for example, burst errors.

For DRAM failures, it is preferable or easier when errors or data failures are all aligned with symbol boundaries to improve the efficiency of error correction e.g., RS correction. For example, in the case of RS, RS code can require two times or 2X number of ECC symbols to correct X symbols of errors. In other words, RS codes can be computationally intensive whereas error correction for DRAM can require low-latency and fast error correction.

In at least one aspect or embodiment, an error correction code, such as RS, is combined with erasure code. This approach can handle the internal and via/connector failures with overall reduced overhead.

For example, erasure code can be implemented to use X number of ECC symbols to correct or regenerate X number of data symbols when their locations are known. In such instances, the ECC bit overhead is 50% of what RS code would need.

However, the error location may not be known. According to the at least one embodiment, all possible or probably locations are attempted and the location that matches the 1DQ failure pattern is selected.

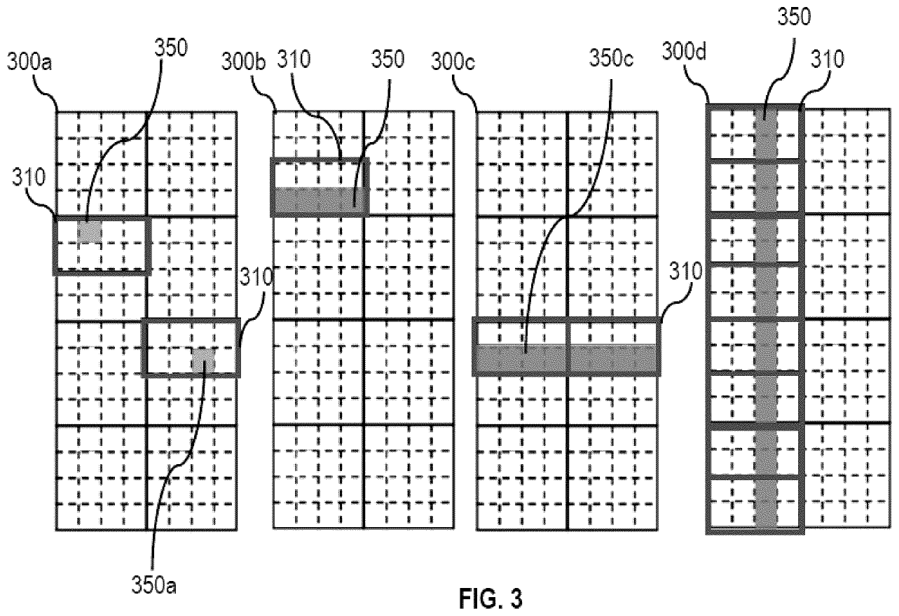

FIG. 3 shows stacked memories (300a-300d) illustrating some examples of memory faults within the memory sections 300a-300d in accordance with one or more aspects or embodiments.

In FIG. 3, each box may correspond to 1-bit or single bit DQ. In the memory section 300a, for instance, errors or error regions 350 are shown. The boxes 310 denote or represent ECC symbols.

For instance, in some of the memory sections 300a-300d the two boxes 310 (two ECC symbols) are used to regenerate data for the left 4 DQs and right 4 DQs. If the “bad” or faulty DQ is on the left, the correction may result in the remaining three DQs in that group resolving to all zero.

Further it is unlikely that the right 4 DQs exhibit the same pattern. Even if they do, this instance can be considered or treated as an uncorrectable error to avoid a miscorrection.

Thus, the total number of ECC symbols is reduced from 16 to 8. Further, the RS correction strength is reduced from 8 to 2.

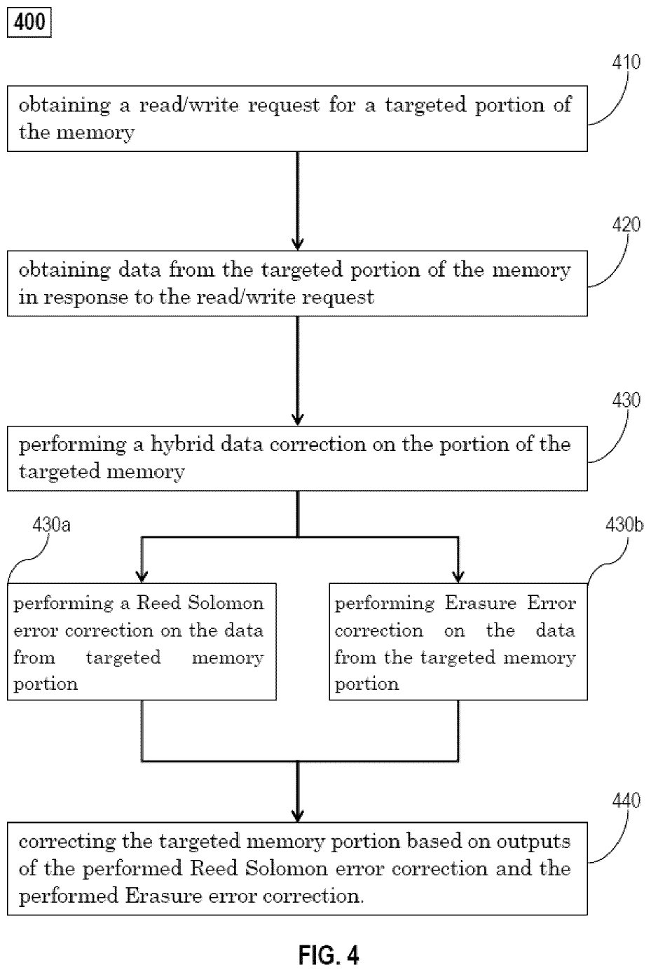

FIG. 4 includes a flowchart illustrating an embodiment of a process or method 400 for correcting data errors in a memory device, such as the memory device 100.

The method 400 includes, at 410, obtaining, by a memory controller 121 operatively coupled to a memory including at least one memory die layer, a read or write request for a targeted portion of the memory.

At 420, the method 400 includes obtaining data from the targeted portion of the memory in response to the read or write request.

At 430, the method 400 includes performing hybrid data correction on the data from the targeted portion of the memory.

Performing the hybrid data correction (430) includes at 430a, performing Reed Solomon error correction on the data from the targeted memory portion and at 430b, performing erasure error correction on the data from the targeted memory portion.

The method at 400 further includes at 440, correcting the targeted memory portion based on outputs of the Reed Solomon error correction and the erasure error correction.

In at least one example, system layer 120 includes a memory controller 121 operatively coupled to memory 100, and is configured to perform the method 400. This includes, obtaining a read or write request for a targeted portion of the memory; retrieving data from the targeted portion in response to the request; performing hybrid data correction by applying Reed Solomon and erasure correction independently; and correcting the data based on the outputs of the applied error correction techniques.

In such examples, the memory (e.g., memory 110) can be a 2D memory or a 3D/stacked memory including a plurality of memory die layers. Further, the memory may be a Double Data Rate (DDR), Low Power Double Data Rate (LPDDR), or High Bandwidth Memory (HBM) type memory.

In addition, the memory controller 120 can be configured to perform the Reed Solomon error correction and the Erasure error correction independently of each other.

Further, correcting the targeted memory portion may include applying only one of the Reed Solomon or erasure error correction techniques, depending on which one produces a successful result

For instance, after performing both error correction methods, the outputs may fall into one of several cases:
1. If both Reed Solomon and erasure correction produce the same result, the correction is accepted as valid. Either output may be used.
2. If only one of the methods produces a valid correction, that method is used. The controller applies the output of the successful correction only.
3. If both correction methods fail or produce conflicting results, the memory controller designates the data as uncorrectable. It may update internal registers to mark the region as faulty and optionally initiate higher-level correction (e.g., RAID or system-level redundancy).

Further, the method 400 may be performed so that the Reed Solomon error correction is performed using a first predefined symbol boundary and while the Erasure error correction is performed using a second symbol boundary, which is different from the first. For example, the first symbol boundary may be aligned burst-wise, while the second symbol boundary may be aligned DQ-wise or column-wise. In at least one embodiment, the Reed Solomon error correction is configured to correct random symbol errors, while the erasure error correction is configured to correct grouped symbol errors occurring at one or more known memory locations. This embodiment may be applied to any memory type, for example 2D memories and 3D memories.

Referring back to FIG. 1, the memory device 100 includes a repair table, which may be part of the memory 110. With the repair table being a type of memory, the repair table may possibly become corrupt and unusable. In at least one example, the repair table may reside in a portion of memory 110 that is both physically and logically separated from the main memory.

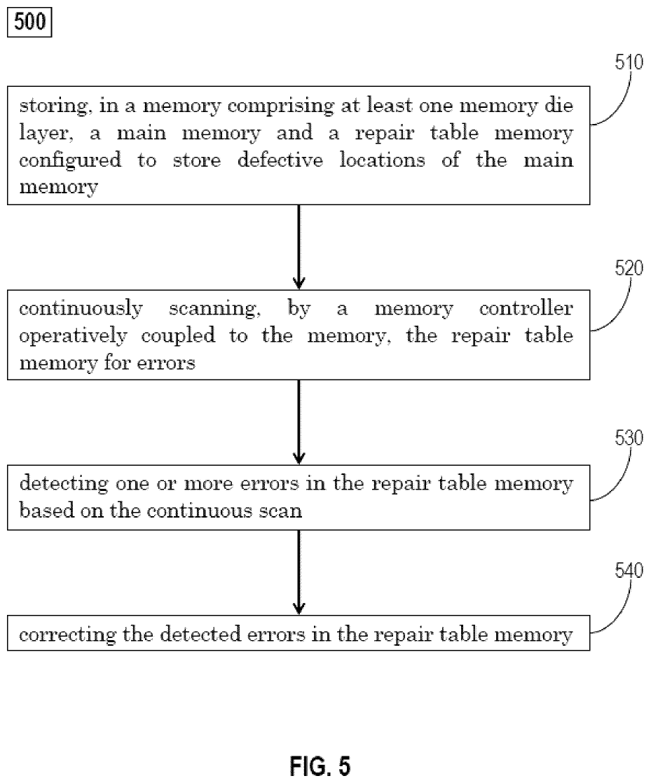

According to at least one embodiment, FIG. 5 illustrates a flowchart of a method 500 that may be performed using a memory device such as the memory device 100 of FIG. 1.

The method 500 includes, at 510, storing, in a memory comprising at least one memory die layer, a main memory and a repair table memory configured to store defective locations of the main memory.

At 520, the method 500 includes continuously scanning, by a memory controller operatively coupled to the memory, the repair table memory for errors.

At 530, the method 500 includes detecting one or more errors in the repair table memory based on the continuous scan.

At 540, the method 500 includes correcting the detected errors in the repair table memory.

In at least one embodiment, a memory device (e.g., memory device 100) includes a memory (e.g., memory 110) including both a main memory and a repair table memory configured to store defective locations of the main memory. A memory controller (e.g., memory controller 121), operatively coupled to memory 110, is configured to: continuously scan the repair table memory for errors; detect one or more errors in the repair table memory from the continuous scan; and correct the detected errors in the repair table memory.

In some examples, the memory controller is configured to correct a specific detected repair table memory entry immediately upon detecting an error in that entry.

In some examples, the memory controller is further configured to continue handling memory access requests using the repair table while correcting a detected error therein.

In certain embodiments, the repair table memory is implemented as a lookup table that maps defective locations in the main memory to corresponding spare memory location addresses when the original locations were deemed corrupt and unusable.

Additionally, in at least one example, correcting a repair table memory entry may include refreshing or reloading the entry (e.g., only the faulty entry) with a correct version, such as from a trusted copy, for instance.

According to at least one embodiment, the repair table may be implemented by flops (rather than, for example, SRAM, which may be used in at least one other embodiment).

The flop-based design may require a little bit more area, but by trading off a little bit of area, the performance improves with the flop-based design.

An increase in required power may be negligible in this case, because the size of the additional area is small.

This design choice may allow access to each entry in the repair table for constant comparison of ECCs, irrespective of whether a request is present or not.

When a request arrives, an error may have already been repaired. In a worst case, a repair may still need to be completed. In this case, a performance may be the same as for the traditional implementation. The following table summarizes various scenarios that have been described above:

| | | | Latency |
|---|---|---|---|
| Case | Scenario | Action | Savings |
| 1 | Incoming address matches | Remap and move on | a. NA |
| | with an entry | | b. Saving from |
| | a. No error is present | | early correction |
| | b. Error has been fixed | | |
| 2 | Incoming address matches | Remap and move on | Saving from |
| | with an entry while another | | parallel operation |
| | entry is being updated due to | | |
| | corruption. | | |
| 3 | Incoming address does not | a. Bypass the remap | a. NA |
| | match any entry | table | b. Reduction on |
| | a. No error is present in the | b. Compare the | false no-match |
| | table | incoming address | and overall |
| | b. Error is detected in some | with the corrupted | reduction in |
| | entries | entry. Count the | latency to avoid |
| | | mismatching bits. | false no-match |
| | | 1. Count is less | b1. Similar latency |
| | | than or equal to | as traditional |
| | | number M, a | approach |
| | | potential match can | b2. NA |
| | | be found but it is | |
| | | not guaranteed until | |
| | | the line has been | |
| | | reloaded. Therefore, | |
| | | Nack the packet. | |
| | | 2. Greater than M | |
| | | mismatches indicate | |
| | | a completely | |
| | | different address. | |
| | | Bypass the remap | |
| | | table. | |
| | | M is chosen based on | |
| | | Hamming distance | |

Case 3, action b) of various embodiments may reduce a possibility of a false no-match:

In some approaches, a no-match may be falsely determined, due to a corruption in the repair table causing the no-match. There is no way of detecting that the no-match is caused by a faulty data entry in the repair table, unless all entries in the repair table are being compared whenever a no-match occurs. This would be a huge latency overhead.

In various embodiments, since the repair table is being scanned routinely, e.g. continuously, the hardware may already know if corruption is present in the entire repair table. The hardware may be able to focus on one corrupt entry of the repair table for further verification. Therefore, a possibility of a false no-match is reduced.

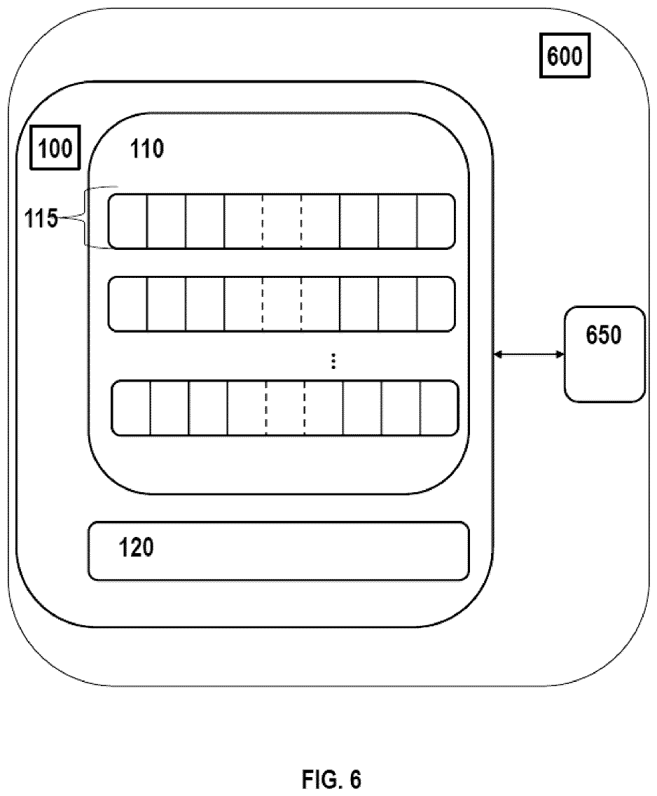

FIG. 6 shows a memory arrangement 600 which may be similar in several respects to the arrangement of FIG. 1. The memory arrangement 600 includes a host controller 650 that interfaces with the memory device 100. The host controller 650 can be implemented as a logic unit or component (e.g., hardware or firmware logic) that facilitates or manages communication between a host system (not shown), like a CPU or SoC, and the memory device 100. The memory device 100 in this example can be or include a type of 3D stacked memory including, such as, for example, HBM or 3D DRAM, to name a few.

The host controller 650 may be located outside the memory device 100. In one example, it may be integrated on a CPU die, a memory controller hub, or chipset. The host controller 650 may coordinate data transfers, control access timings, and handle protocol-level signaling.

As mentioned, in the example of FIG. 6, for the memory device 100, the memory 110 is a stacked memory (e.g., 3D memory) including a plurality of memory die layers, the memory die layers forming a plurality of memory slices. In at least one embodiment, the host controller 650, is operatively coupled to the memory device thorough one or more interfaces and is configured to detect a defective memory slice of the plurality of memory slices and remap memory access from the detected defective memory slice to a spare memory slice of the plurality of memory slices.

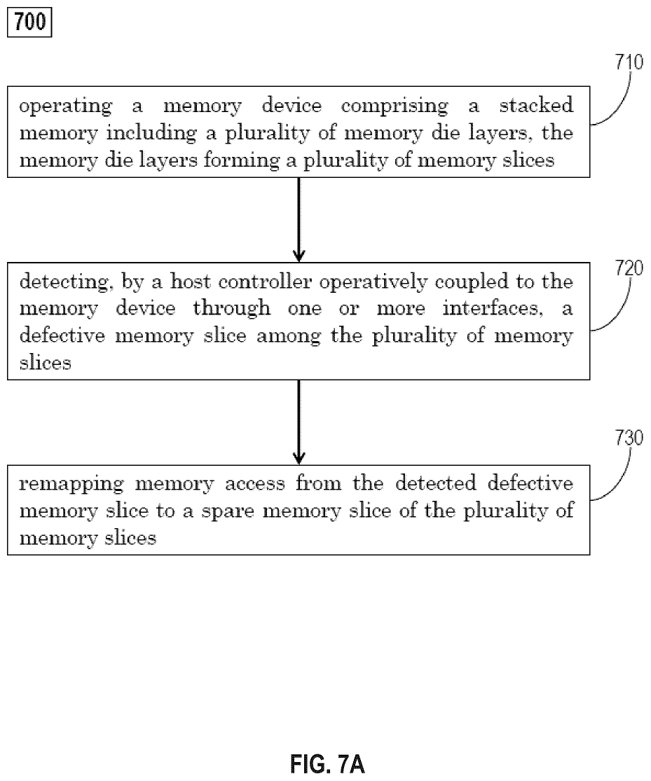

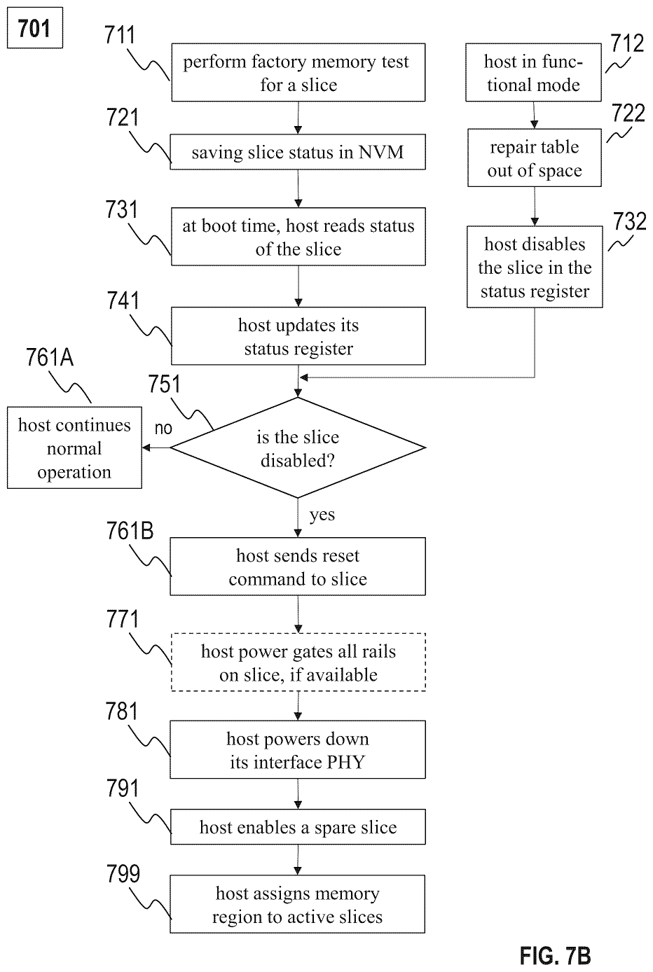

For example, FIG. 7A shows a flowchart of a method 700 that may be implemented by the memory arrangement of FIG. 6, or another similar one, according to at least one embodiment.

The method 700 includes, at 710, operating a memory device comprising a stacked memory including a plurality of memory die layers, the memory die layers forming a plurality of memory slices

At 720, the method 700 includes detecting, by a host controller operatively coupled to the memory device through one or more interfaces, a defective memory slice among the plurality of memory slices.

At 730, the method 700 includes remapping memory access from the detected defective memory slice to a spare memory slice of the plurality of memory slices.

Further, in at least one example, remapping memory access includes disabling the detected defective memory slice. For instance, disabling the detected defective memory slice can include performing power gating or clock gating on the detected defective memory slice by the host controller.

Further, to disable may include implementing, by the host controller, a handshake protocol with the memory device to coordinate disabling the detected defective memory slice and enabling the spare memory slice.

Further, in at least on example, the host controller includes a remap table or remap circuitry, and wherein remapping memory access includes updating the remap table or the remap circuitry to map an address associated with the detected defective memory slice to an address associated with the spare memory slice.

In at least one example, each of the plurality of memory slices is independently addressable by the host controller. Further, the stacked memory includes one or more spare memory slices reserved for use as replacements for detected defective memory slices.

The following describes how a memory arrangement, for example a memory arrangement similar or identical to the memory arrangement as described in context with FIG. 6, which includes a system or host that communicates with the memory cube, determines a defective memory slice and carries out the swapping procedure for a spare memory slice.

Memory errors may for example be detected during any of two different time periods: during a memory test (as a first scenario) prior to functional operation, and/or during functional operation (as a second scenario).

Regarding the first scenario: Memory tests are routinely performed on each slice. At the end of the memory test, a repair table may be created and stored in a safe location such as a fuse, one-time programmable (OTP) memory, or a different type of non-volatile memory (NVM).

An enable/disable bit (1 bit for each memory slice, including the spare memory slice(s)) may be stored alongside the repair table, and a host may implement a status register,

The spare memory slices may have their respective status set to “disabled” initially. In a functional mode, the host may read the slice status from the slice level NVM during boot time and may record the slice status in its own status register.

If a status returns disabled, the host may keep the slice in reset and power down the interface physical layer PHY to save power. If power gating is available on the memory slice, the host may also power gate all rails to completely shut down the memory slice. This may ensure that the disabled memory slice does not drain additional power, e.g. from a clock and/or through leakage current.

When the software programs a memory map, the host may assign each memory region to enabled slices only.

In the second scenario, the memory may have passed the initial test but may start showing signs of failing after some time has passed.

The host may receive a huge number of ECC errors for its requests. When the repair table runs out of space, a system manager or a host typically working with telemetry software may determine that it is time to decommission a slice.

When this happens, the system manager or host may directly program the host status register.

This may trigger actions like described above for the first scenario (the test case). The host may stop all requests to the disabled slice and wait for all responses to come back.

Then, the host may send a reset command for keeping the memory slice in reset and may shut down the interface PHY.

The host may update its routing table and may reassign the memory region from the disabled slice to a spare slice.

FIG. 7B show a flow chart 701 of a method according to at least one embodiment.

The method 701 may be performed or implemented in devices or arrangements described herein, such as the memory device 100 of FIG. 1, the memory arrangement 600 of FIG. 6, or other similar devices or arrangements, respectively.

At 711, the method 701 includes performing factory memory test for a memory slice.

At 721, the method 701 includes saving the slice status in NVM.

At 731, the method 701 includes that, at boot time, the host reads a status of the memory slice.

At 741, the host updates its status register.

The processes 711 to 741 may form a first branch of the flow chart 701, which may correspond to the first (test) scenario described above.

A parallel branch including the processes 712 to 732 may correspond to the second (functional mode) scenario.

At 712, the host is in functional mode.

At 722, the repair table runs out of space.

And at 732, the host disables the slice in the status register.

After 741 and 732, respectively, both branches may follow the same path.

At 751, it is determined if the slice is disabled (or not).

If it is determined that the slice is not disabled, the host continues, at 761A, normal operation.

If it is determined that the slice is disabled, the host continues, at 761B, with sending a reset command to the memory slice.

At 771, which is an optional process, the host power gates all rails on the memory slice.

At 781, the host powers down its interface PHY.

At 791, the host enables a spare memory slice.

And at 799, the host assigns a memory region to active slices.

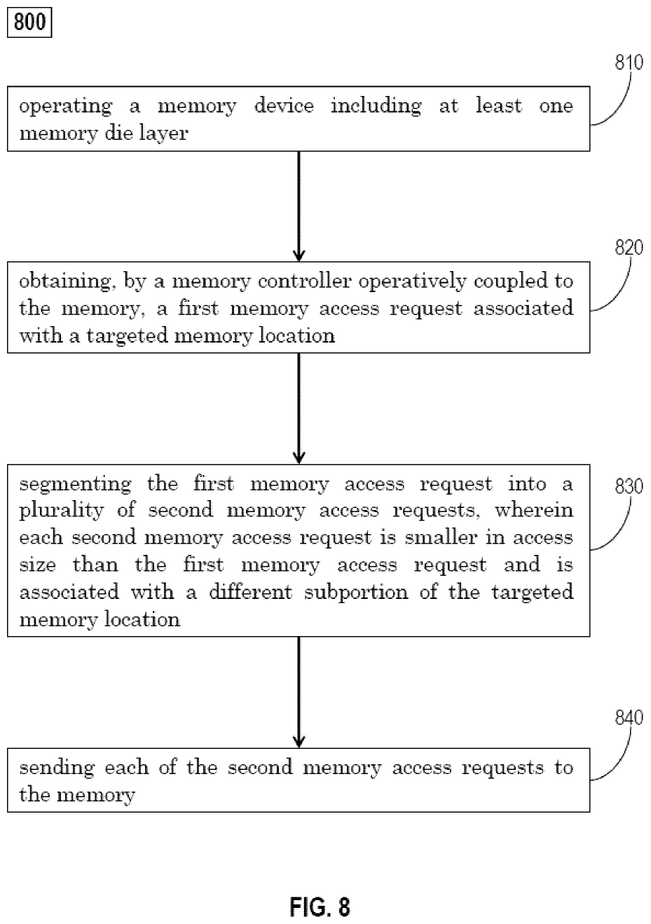

FIG. 8 illustrates a flow chart of a method 800 according to at least one embodiment.

The method 800 may be performed or implemented in devices or arrangements described herein, such as the memory device 100 of FIG. 1 or other similar devices.

At 810, the method 800 includes operating a memory device including at least one memory die layer.

At 820, the method 800 includes obtaining, by a memory controller operatively coupled to the memory, a first memory access request associated with a targeted memory location.

At 830, the method 800 includes segmenting the first memory access request into a plurality of second memory access requests, wherein each second memory access request is smaller in access size than the first memory access request and is associated with a different subportion of the targeted memory location.

At 840, the method 800 includes sending each of the second memory access requests to the memory.

Accordingly, in at least one embodiment, a memory device (e.g., memory device 100) includes a memory (e.g., memory 110) that includes at least one memory die layer and a memory controller (e.g., memory controller 120). The memory controller is operatively coupled to the memory. Further, in at least one example, the memory controller is configured to: obtain a first memory access request associated with a targeted memory location; segment the first memory access request into a plurality of second memory requests, wherein each second memory access request is smaller in access size than the first memory access request and is associated with a different subportion of the targeted memory location; and send each of the second memory access requests to the memory.

Segmenting, as used herein, may refer to the electronic transformation or processing of a memory access request into two or more smaller access commands, each of which corresponds to a distinct subportion of the original targeted memory location.

Further, in some examples, each of the second memory access requests is sent to the memory in parallel through a plurality of interfaces. For example, where the memory is dynamic random access memory (DRAM), the interfaces are DRAM interfaces.

Further, in some examples, the first memory access request can be or include a write access request while in other cases, the first memory access request can include or be a read access request.

Further, in some examples, the memory controller (e.g., memory controller 121) is configured to segment the first memory access request into the plurality of second memory access requests, e.g., by splitting the first memory access request into two second memory access requests each having an access size that is half of the first memory access request. In other cases, the memory controller is configured to split the first memory access request into four second memory access requests each having an access size that is one-quarter of the first memory access request. Yet in other cases, the memory controller is configured to split the first memory access request into eight second memory access requests each having an access size that is one-eighth of the first memory access request.

In some examples, the memory (e.g., memory 110) is a 2D memory, while in other instances, the memory is a 3D or stacked memory including a plurality of stacked memory die layers.

In at least one instance, the memory controller is configured to select a striping mode from a plurality of available striping modes based on a value stored in one or more control registers (e.g., of the memory controller 121). For instance, the striping mode indicates a number of second memory access requests into which the first memory access request is to be split.

The 3D or stacked memory including a plurality of stacked memory die layers may include multiple interfaces to the memory.

In some approaches, when the connected host makes a memory request, the memory controller processes this request (decodes operation, remaps address, etc.) and sends it to one of the memory interfaces it is managing.

This interface will have a certain latency for activating the connected memory, reading/writing the data and ECC bits in a number of data chunks (burst length) which depend on a width of the data interface.

For example, if the data width of the memory interface is 80-bits (10 bytes), and each memory read/write contains a total of 64B data plus 16B ECC (80-bytes), then a complete data transfer will require eight bursts of burst length eight bytes.

Therefore, in this approach, each memory access will have a latency of the activation of the memory itself (latency A), plus the latency of a data burst (latency B), multiplied by the number of data bursts. A simplified memory latency of this device using the described approach would be L=A+8B.

In at least one embodiment, a latency incurred by the burst length is reduced by dividing a memory request across multiple memory interfaces (referred to as striping) the memory controller is managing.

The memory controller would break down an incoming address based on the striping granularity and send the request to multiple memory interfaces in parallel, thus dividing down the number of serial burst lengths required to read/write all the data for the operation. Meanwhile, the initial activation time from multiple memory interfaces is parallelized

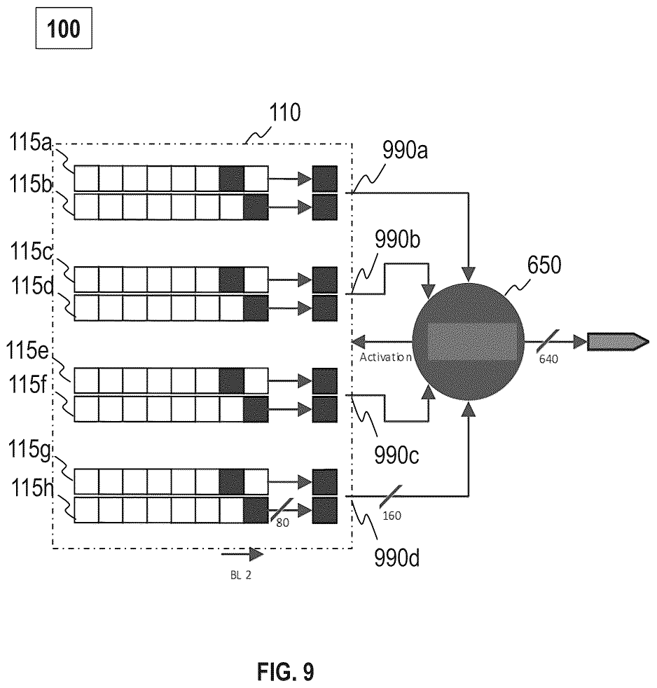

The above approach is used for a comparison with the at least one embodiment, and FIG. 9, which shows a diagram illustrating an example of a memory device including a memory controller and a memory comprising one or more memory die layers and a method of using it according to the at least one embodiment, is provided as an illustration.

A memory controller 650 may stripe a, for example, 64 Byte read/write request to, for example, four different memory interfaces 990a, 990b, 990c, 990d, activating them in parallel.

As opposed to the above approach, this would result in four parallel data bursts of length two, instead of one data burst of length eight.

The controller 650 would then be responsible for collecting the four chunks of data (originating from the memory slices 115a through 115h) from the four memory interfaces 990a to 990d (on a read request) and combining them into a single chunk of data before returning to the host. In this scenario, the total latency would be L=A+2B.

In this exemplary embodiment, the total latency of the burst length is thus reduced by a factor of four over the approach that was used for comparison.

Note that the upper bits of the memory device are simply mapped to a different address, which is the responsibility of the controller 650 to set the correct row and column addresses of the memory device 100 for that request.

For write requests, this process works in reverse, with the controller 650 first dividing the data into four sets, and then sending these to each of the four involved memory interfaces 990a, 990b, 990c, 990d.

Based on the architecture of the memory device 100 (data width of a memory interface, number of memory interfaces 990a, 990b, . . . that exist in the memory device 100, size of the requests that need to be supported etc.), this method may be applied and optimized for the architecture.

This may lead to more complexity in the controller logic, which may increase the number of clock cycles needed for servicing requests. However, these clock cycles will be of a much smaller latency (one or two memory controller clock cycles), versus read-out time of a chunk of data from the memory device 100 itself.

In at least one embodiment, the parallel access may be used at slice level.

In a multi-layer memory device, each memory slice may operate independently.

When a system/host sends a request to the memory, that request can be split into multiple requests to different memory slices before it is sent out.

The mapping of the slice address may be application specific. It may for example depend on how the system including software addresses the memory. The mapping may be applied in the host where an address map typically resides.

The embodiments described herein provide several technical benefits and improvements over other memory systems. For example, hybrid error correction techniques combining Reed-Solomon and erasure correction enable more robust and flexible data recovery under varying fault conditions, while reducing the need for overprovisioned correction strength. Continuous monitoring and correction of the repair table enhances system reliability and longevity by ensuring fault-tracking infrastructure remains accurate and operational. Slice-level remapping managed by a host controller allows efficient isolation and substitution of defective memory layers, which helps preserve usable capacity and prevents system-level failures. Additionally, striping memory access requests across multiple interfaces increases memory bandwidth utilization and reduces latency, thereby improving performance in data-intensive applications. Collectively, these features support higher fault tolerance, better performance scalability, and greater memory system resilience in advanced packaging and stacked memory configurations.

Any of the aspects, examples, instances, and/or embodiments described herein may be suitable or appropriately combined including combined with the embodiments or examples described herein.

The word “exemplary” is used herein to mean “serving as an example, instance, or illustration.” Any example or design described herein as “exemplary” is not necessarily to be construed as preferred or advantageous over other examples or designs.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. The appearances of the phrase “for example,” “in an example,” or “in some examples” are not necessarily all referring to the same example.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

The term “connected” or “on” can be understood in the sense of a (e.g. mechanical, optical and/or electrical), e.g. direct or indirect, connection and/or interaction. For example, several elements can be connected together mechanically such that they are physically retained (e.g., a plug connected to a socket) and electrically such that they have an electrically conductive path (e.g., signal paths exist along a communicative chain).

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

As utilized herein, terms “module”, “component,” “system,” “circuit,” “element,” “slice,” “circuitry,” and the like are intended to refer to a set of one or more electronic components, a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuits can reside within the same circuitry, and circuitry can be localized on one computer and/or distributed between two or more computers. A set of elements or a set of other circuits can be described herein, in which the term “set” can be interpreted as “one or more.”

Such electric or electronic circuitry can be operated by a software application or a firmware application executed by one or more processors. The one or more processors can be internal or external to the apparatus and can execute at least a part of the software or firmware application. As yet another example, circuitry can be an apparatus that provides specific functionality through electronic components without mechanical parts; the electronic components can include one or more processors therein to execute executable instructions stored in non-transitory computer readable storage medium and/or firmware that confer(s), at least in part, the functionality of the electronic components. As another example, circuitry or similar term can be implemented in hardware such as application specific integrated circuit (ASIC), programmable gate array (PGA), discrete digital circuits, etc.) or in a combination of hardware and software (e.g., a software model executed by a corresponding processor).

The term “semiconductor substrate” can mean any construction comprising semiconductor material, for example, a silicon substrate with or without an epitaxial layer, a silicon-on-insulator substrate containing a buried insulator layer, or a substrate with a silicon germanium layer.

A lateral direction is understood to mean a direction that runs, in particular, parallel to a main extension surface of the component, in particular of a layer. A vertical direction is understood to mean a direction that is oriented, in particular, perpendicular to the main extension surface of the component and/or layer. The vertical direction and the lateral direction are approximately orthogonal to each other.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term data, however, is not limited to the aforementioned examples and may take various forms and represent any information as understood in the art.

As used herein, a signal that is “indicative of” a value or other information may be a digital or analog signal that encodes or otherwise communicates the value or other information in a manner that can be decoded by and/or cause a responsive action in a component receiving the signal. The signal may be stored or buffered in computer readable storage medium prior to its receipt by the receiving component and the receiving component may retrieve the signal from the storage medium. Further, a “value” that is “indicative of” some quantity, state, or parameter may be physically embodied as a digital signal, an analog signal, or stored bits that encode or otherwise communicate the value.

Unless otherwise stated, the words “about” and “substantially” as used herein are to be construed as meaning the normal measuring and/or fabrication limitations related to the value or condition which the word “about” or “substantially” modifies. Unless expressly stated otherwise, the term “embodiment” is used herein to mean an embodiment of the present disclosure.

As used herein, a signal may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered as the same signal. For example, a transmit signal may be considered as referring to the transmit signal in baseband, intermediate, and radio frequencies.

While the above descriptions and connected figures may depict device components as separate elements, skilled persons will appreciate the various possibilities to combine or integrate discrete features, functions into a single element. Such may include combining two or more components into a single component. Conversely, skilled persons will recognize the possibility to separate a single element into two or more discrete elements, such as splitting a single component into two or more separate components.

It is appreciated that implementations of methods detailed herein are exemplary in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

While embodiments of the present disclosure have been described above, it is obvious that further embodiments may be implemented. For example, further embodiments may comprise any subcombination of features recited in the claims or any subcombination of elements described in the examples given above. Accordingly, this spirit and scope of the appended claims should not be limited to the description of the embodiments contained herein.

While the disclosure has been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

What is claimed is:

1. A memory device comprising:
a memory including at least one memory die layer;
a memory controller operatively coupled to the memory, wherein the memory controller is configured to:
obtain read/write request for a targeted portion of the memory;
obtain data from the targeted portion of the memory in response to the read/write request;
perform a hybrid data correction on the portion of the targeted memory comprising to:
perform a Reed Solomon error correction on the data from targeted memory portion;
perform Erasure error correction on the data from the targeted memory portion; and
correct the targeted memory portion based on outputs of the performed Reed Solomon error correction and the performed Erasure error correction.

2. The memory device of claim 1,
wherein the memory is selected from a group consisting of:
a 2D memory; and. a 3D or stacked memory comprising a plurality of memory die layers.

3. The memory device of claim 1,
wherein the memory comprises Double Data Rate (DDR), Low Power Double Data Rate (LPDDR), or High Bandwidth Memory (HBM) type memory.

4. The memory device of claim 1,
wherein the memory device is configured to perform the Reed Solomon error correction and the Erasure error correction independently of each other.

5. The memory device of claim 1,
wherein to correct the targeted memory portion based on the performed Reed Solomon error correction and the Erasure error correction comprises the memory controller configured to correct the targeted memory portion by applying only one of the Reed Solomon error correction or the Erasure error correction.

6. The memory device of claim 5,
wherein the memory device is configured:
to select the Reed Solomon error correction to apply to the targeted memory based on Reed Solomon error correction performing error correction successfully and the Erasure error correction not performing error correction successfully; or
to select the Erasure error correction to apply to the targeted memory based on the Erasure error correction performing error correction successfully and the Reed Solomon error correction not performing error correction successfully; or
to select either Reed Solomon error correction the Erasure error correction to apply to the targeted memory based on the performed Reed Solomon error correction and the performed Erasure error both performing error correction successfully.

7. The memory device of claim 1,
wherein to correct the memory comprises, in response to the Reed Solomon and Erasure error corrections produce conflicting and incorrect results, the memory controller is configured to identify the error as uncorrectable.

8. The memory device of claim 1,
wherein the memory controller is configured to perform Reed Solomon error correction using a first predefined symbol boundary and perform the Erasure error correction using a second symbol boundary different from the first.

9. A memory device comprising:
a memory including at least one memory die layer, the memory comprising:
a main memory, and
a repair table memory configured to store defective locations of the main memory;
a memory controller, operatively coupled the memory, wherein the memory controller is configured to:
continuously scan the repair table memory for errors;
detect one or more errors in the repair table memory from the continuous scan;
correct the detected errors of the repair table.

10. The memory device of claim 9,
wherein the memory controller is configured to correct specific detected repair table memory entry immediately in response to detecting an error therein.

11. The memory device of claim 9,
wherein the memory controller is configured to handle memory requests using the repair table while correcting a detected error in the repair table memory.

12. The memory device of claim 9,
wherein the repair table memory comprises a lookup table mapping defective locations of the main memory to spare memory location addresses.

13. The memory device of claim 9,
wherein the to correct a repair table memory entry comprises to refreshing or reloading the entry with a correct version.

14. A memory arrangement comprising:
a memory device comprising:
a stacked memory including a plurality of memory die layers, the memory die layers forming a plurality of memory slices;
a host controller operatively coupled to the memory device thorough one or more interfaces, the host controller configured to:
detect a defective memory slice of the plurality of memory slices;
remap memory access from the detected defective memory slice to a spare memory slice of the plurality of memory slices.

15. The memory arrangement of claim 14,
wherein to remap memory access comprises the host controller is configured to disable the detected defective memory slice.

16. The memory arrangement of claim 15,
wherein to configured to disable the detected defective memory slice comprises the host controller configured to perform clocking gating of the detected defective memory slice.

17. The memory arrangement of claim 15,
wherein the host controller is configured to implement a handshake protocol with the memory device to coordinate disabling the detected defective memory slice and to enable the spare memory slice.

18. The memory arrangement of claim 14,
wherein the host controller comprises a remap table or remap circuitry, and
wherein the host controller being configured to remap memory access comprises the host controller being configured to update the remap table or the remap circuitry to map an address associated with the detected defective memory slice to an address associated with the spare memory slice.

19. The memory arrangement of claim 14,
wherein each of the plurality of memory slices is independently addressable by the host controller.

20. The memory arrangement of claim 14,
wherein the stacked memory includes one or more spare memory slices safeguarded for use as replacements for detected defective memory slices.
